(19) United States
(12) Patent Application Publication
(10) Pub. No.: US 2007/0189111 A1
(43) Pub. Date: Aug. 16, 2007

(54) System for Converting Hydrokinetic Energy to Mechanical Energy

(76) Inventor: Roberto M. Garza, San Antonio, TX (US)

Correspondence Address: GUNN & LEE, P.C., 700 N. ST. MARY'S STREET, SUITE 1500, SAN ANTONIO, TX, 78205, US

(21) Appl. No.: 11/673,743

(22) Filed: Feb. 12, 2007

Related U.S. Application Data
(60) Provisional application No. 60/773,692, filed on Feb. 15, 2006.

(51) Int. Cl. B01F 13/02

(52) U.S. Cl. 366/102

(57) ABSTRACT

A system for converting hydrokinetic energy into mechanical energy. The system includes a holding tank, a housing containing a turbine, and a power take-off connected to the turbine for providing mechanical energy to outside the system. At least one mixing chamber with a discharge opening is connected to the housing for receiving a fluid therefrom. A gas is communicated into the mixing chamber, which causes a circulatory flow of the fluid within the holding tank that is used to spin the turbine.

### CROSS REFERENCE TO RELATED APPLICATIONS

This is an original non-provisional application claiming benefit of U.S. Provisional Application 60/773,692, filed Feb. 15, 2006, which is incorporated herein by reference.

### STATEMENT REGARDING FEDERALLY SPONSORED RESEARCH OR DEVELOPMENT

Not applicable.

### BACKGROUND OF THE INVENTION

### Field of the Invention

The present invention relates generally to a hydrokinetic energy to mechanical energy conversion system. More specifically, the invention causes circulation of a fluid to turn a turbine by injecting a gas into a volume of the liquid. As the gas rises to the volume surface, the low pressure area under the gas rises, causing fluid to fill the lower pressure area. This results in a fluid circulation effect that causes the turbine to spin.

### BRIEF SUMMARY OF THE INVENTION

The present invention is an energy conversion system for converting hydrokinetic energy from a flowing fluid into mechanical energy. The system includes a housing having an intake opening, a turbine contained within the housing, and a power take-off connected to the turbine for providing mechanical energy from the turbine to outside the system. A connected mixing chamber with a with a discharge opening is connected to the housing for receiving a fluid therefrom. As gas is communicated into the mixing chamber, a circulatory flow of the fluid results within the holding tank, which spins the turbine to produce mechanical energy.

### BRIEF DESCRIPTION OF THE SEVERAL VIEWS OF THE DRAWING

The present invention, as well as further objects and features thereof, are more clearly and fully set forth in the following description of the preferred embodiment, which should be read with reference to the accompanying drawings, wherein:

FIG. 1 discloses a partial sectional view of the preferred embodiment of the present invention;

FIG. 2 shows partial sectional view an alternative embodiment of the present invention; and

FIG. 3 is a partial section view of the regulating tank along section line 3-3 of FIG. 2.

### DETAILED DESCRIPTION OF THE INVENTION

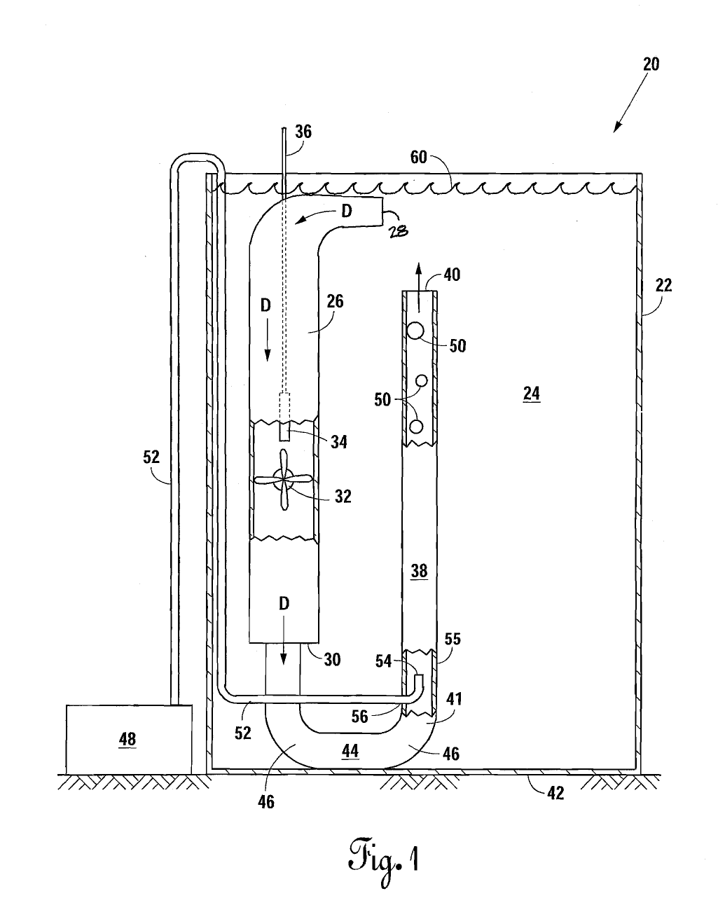

FIG. 1 discloses the preferred embodiment of the present invention that includes a holding tank 22 capable of containing a volume 24 of fluid. The system 20 further comprises a cylindrical housing 26 having an intake opening 28 and open bottom 30. The housing 26 is preferably made from PVC, but may be made from virtually any material suitable for submerged use. A turbine 32, or “water wheel,” is mounted inside the housing 26 and positioned such that fluid flowing through the housing 26 along a path D causes the turbine to extract energy therefrom. As fluid flows through the housing 26 along the path D, the turbine 32 turns, providing mechanical energy to an attached power take-off 34, which is attached to a splined turbine shaft 36 that extrudes from the housing 26. The use The use of turbines in such a manner is well known in the art.

The bottom 30 of the housing 26 is connected to a mixing chamber 38 having a discharge opening 40 and bottom 41. The mixing chamber 38 is also preferably a PVC cylinder. The longitudinal axis of the mixing chamber 38 is oriented perpendicularly to the base 42 of the holding tank 22. The bottom 30 of the housing 26 and bottom 41 of the mixing chamber 38 are connected by a PVC pipe 44 and appropriate junctions 46 that are known to those having ordinary skill in plumbing. Although the preferred embodiment of the invention discloses only one mixing chamber 38, any number of mixing chambers may be used.

An air compressor 48 located externally of the holding tank 22 provides a gas 50 into the mixing chamber 38 through a hose 52, the end 54 of which is disposed near the bottom 41 of the chamber 38. The hose 52 is positioned through the sidewall 55 of the mixing chamber 38, and the junction 56 between the hose 52 and sidewall 55 is sealed to prevent fluid communication between the interior of the mixing chamber 38 and the volume 24 of fluid, except through the discharge opening 40 and bottom 41.

When the gas 50 is released into the mixing chamber 38 through the hose 52, the lower density of the gas 50 relative to the surrounding fluid causes the gas 50 to rise through the fluid within the mixing chamber 38 and exit through the discharge opening 40 to the fluid volume surface 60. As the gas 50 rises in the mixing chamber 38 and to the surface 60, the low pressure region beneath the rising gas 50 causes circulation of the fluid 24 held by the tank 22 into the housing 26 through the intake opening 28, past the turbine 32, and into the mixing chamber 38 along path D. The fluid circulation thus causes hydrokinetic energy to be provided to the turbine 32, which converts the energy to mechanical energy provided to the splined shaft 36 via the power take-off 34. This circulating movement will continue so long as the gas 50 is communicated into the mixing chamber chamber 38. Prior to operating the embodiment, the holding tank must be filled with the fluid volume 24 such that the housing intake 28, the mixing chamber 38, and the discharge opening 40 are submerged.

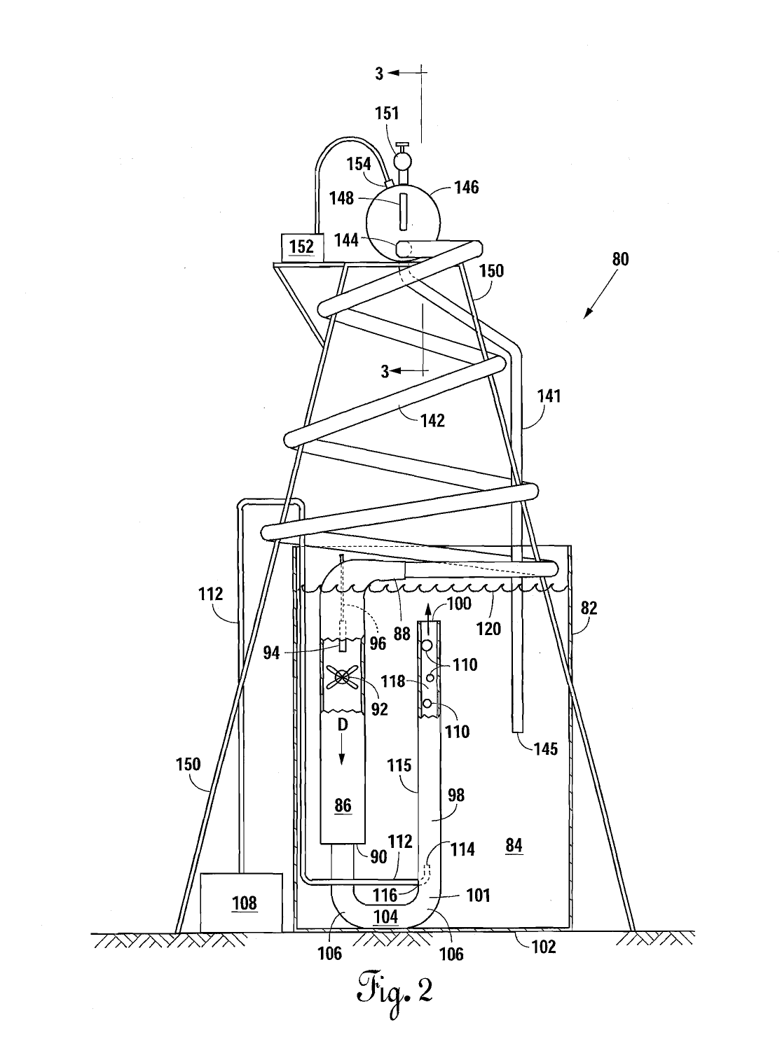

FIG. 2 shows an alternative embodiment of the invention in which the energy conversion system 80 includes a holding tank 82 containing a volume 84 of fluid. The system 80 further comprises a cylindrical housing 86 having an intake opening 88 and open bottom 90. As described with reference to the preferred embodiment, the housing 86 is preferably made from PVC, but may be made from virtually any material suitable for submerged use.

A turbine 92, or “water wheel,” is mounted inside the housing 86 and positioned such that fluid flowing through the housing 86 causes the turbine 92 to extract energy therefrom. As fluid flows through the housing 86 along a path D, the turbine 92 turns, providing mechanical energy to an attached power take-off 94 that is connected to a splined turbine shaft 96. The use of turbines in such a manner is well known in the art.

The bottom 90 of the housing 86 is connected to a mixing chamber 98, which is also preferably a PVC cylinder, having a discharge opening 100 and a bottom 101. The longitudinal axis of the mixing chamber 98 is oriented perpendicularly to the base 102 of the holding tank 82, although any generally upward orientation will suffice. The bottom 90 of the housing 86 and bottom 101 of the mixing chamber 98 are connected with a PVC pipe and appropriate junctions 106 that are known to those having ordinary skill in the plumbing.

An air compressor 108 located outside of the holding tank 82 provides gas 110 into the mixing chamber 98 through a hose 112, the end 114 of which is disposed near the bottom 101 of the mixing chamber 98. The hose 112 is positioned through the sidewall 115 of the mixing chamber 98, and the junction 116 between the hose 112 and sidewall 115 is sealed to prevent fluid communication communication between the interior of the mixing chamber 98 and the volume 84 of fluid except through the discharge opening 100. Although this alternative embodiment of the invention discloses only one mixing chamber, any number of mixing chambers may be used.

As shown in FIG. 2, the alternative embodiment of the system 80 further comprises a discharge line 142 connected to the intake opening 88 of the housing 86. An intake opening 145 of a supply line 141 is disposed in the fluid volume 84. A regulating tank 146 having a sight glass 148 is positioned at an altitude higher than the holding tank 82 and is interposed between the supply line 141 and discharge line 142. The supply line 141, discharge line 142, and regulating tank 146 are supported by a frame 150.

When the gas 110 is released into the mixing chamber 98 through the hose end 114, the lower density of the gas 110 relative to the surrounding fluid volume 84 causes the gas 110 to rise through the fluid within the mixing chamber 98 and exit through the discharge opening 100 to the fluid surface 120. As the gas 110 rises through the mixing chamber 98 and to the fluid surface 110, the low pressure beneath the rising gas 110 is filled with fluid in the mixing chamber 98, causing circulation of the fluid contained by the tank 82 into the supply line 141 through the intake opening 145.

During normal operation of this embodiment, gas from the fluid moving through the supply line 141 will tend to accumulate within the regulating tank 146. A float switch (not shown) contained therein tracks the fluid level within the tank 146. When the fluid level within the regulating tank 146 reaches a predetermined level, the float switch triggers a connected vacuum pump 152 connected to the tank outlet 154. The vacuum pump 152 draws the accumulated gas from the tank 146 through the output to decrease the accumulated gas volume 165. Without the regulating tank 146 and accompanying vacuum pump 152, gas contained in the fluid within the supply line 141 and discharge and discharge line 142 would accumulate within the system 80. During extended operation of the system 80, gas would accumulate to such a level so as to block fluid flow from the supply line 141, thus causing the system 80 to cease operation.

As fluid exits the discharge line 142, it moves into the housing 86 through the connected intake opening 88. Thence forth, operation of the system 80 is identical to that described for the preferred embodiment. Prior to operating this alternative embodiment, the system 80 must be immersed within the fluid volume 84 to the extent that the intake opening 145 of the supply line 141, the mixing chamber 98, and the discharge opening 100 are disposed in the fluid volume 84.

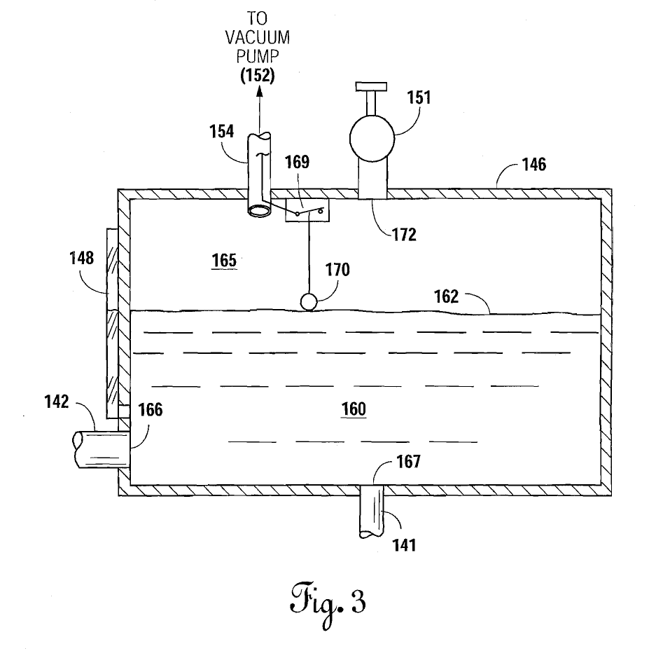

FIG. 3 is a partial sectional view of the regulating tank 146 and components thereof along section line 3-3 of FIG. 2. During operation of the system 80, the regulating tank 146 contains a fluid volume 160 having a corresponding surface 162. Although the fluid volume 160 may initially have had a higher fluid level when first filled through a fill-up valve 151, over time, as gas from the circulating fluid rises through the system 80 and accumulates within the regulating tank 146, the accumulated gas volume 165 forces the fluid surface 162 down. The supply line 141 and discharge line 142 are mated and sealed to the regulating tank 146 at the discharge opening 166 and supply opening 167, respectively. The integrated sight glass 148 provides a means for external observation of the fluid surface 162 within the tank 146.

Actuation means comprising a float switch 169 having a float 170 is disposed within the tank 146 and coupled to the vacuum pump 152 through the tank outlet 154. The float 170 is supported on the fluid volume 160 until the accumulated gas volume 165 suppresses the fluid surface 162 to a predetermined level. When the float 170 is no longer supported by the fluid volume 160, the switch 169 will trip to actuate the vacuum pump 152, which draws the accumulated gas 165 from the regulating tank 146. This allows the surface 162 of fluid volume 160 to once again support the float 170, after which the float switch 169 deactivates the pump 152. According to the preferred embodiment, once actuated, the vacuum pump 152 will run for a predetermined period of time sufficient to reduce the volume of accumulated gas 165 within the tank 146.

The float switch 169 in combination with the vacuum pump 152 prevents gas in the circulating fluid from accumulating to a point where the fluid surface 162 is forced down to the level of the supply opening 167 and discharge opening 166, in which case the accumulated gas 165 would prevent fluid from entering the tank 146 through the supply line 141, thus stopping circulation (and operation) of the system. The interval between actuations of the switch 169—i.e., the amount of time until the accumulation of gas forces the fluid level to drop below the actuation level—is dependent upon characteristics of the fluid as well as environmental characteristics such as altitude above sea level.

The present invention is described above in terms of a preferred illustrative embodiment of a specifically described energy conversion system, as well as alternative embodiments of the present invention. Those skilled in the art will recognize that alternative constructions of such a system can be used in carrying out the present invention. Other aspects, features, and advantages of the present invention may be obtained from a study of this disclosure and the drawings, along with the appended claims.

I claim:

1. An system for converting hydrokinetic energy into mechanical energy comprising:
a holding tank adapted to contain a volume of fluid;
at least one mixing chamber having a discharge opening disposed within said holding tank;
a housing having an intake opening, said housing being connected to said at least one mixing chamber to provide fluid communication thereto;
a turbine contained within said housing and oriented to rotate when a fluid flows through said housing;
a power take-off connected to said turbine; and
a gas source in communication with the interior of said at least one mixing chamber.

2. The system of claim 1 further comprising a fluid volume contained by said holding tank and wherein said intake opening of said housing and said discharge opening are disposed within said fluid volume.

3. The system of claim 1 wherein said gas source is an air compressor having at least one air hose with an end disposed in said at least one mixing chamber.

4. The system of claim 1 further comprising a splined shaft connected to said power take-off.

5. The system of claim 1 further comprising:
a discharge line connected to said intake opening of said housing; and
a supply line having an intake opening disposed within said tank; said supply line being communicably connected to said discharge line.

6. The system of claim 5 wherein said gas source is an air compressor having at least one air hose with an end disposed in said at least one mixing chamber.

7. The system of claim 5 further comprising a splined shaft connected to said power take-off.

8. The system of claim 5 further comprising a fluid volume contained by said holding tank and wherein said intake opening of said supply line is disposed within said fluid volume.

9. The system of claim 5 further comprising:
a regulating tank interposed between said supply line and said discharge line and having a tank outlet;
a vacuum pump connected to said tank outlet; and
actuation means operably connected to said vacuum pump for actuating said vacuum pump when at least a predetermined volume of a gas has accumulated within said regulating tank.

10. The system of claim 9 wherein said actuation means comprises a float switch having a float, said float switch being disposed within said regulating tank and operably connected to said vacuum pump.
